(19) United States
(12) Patent Application Publication
(10) Pub. No.: US 2016/0276741 A1
(43) Pub. Date: Sep. 22, 2016

(54) ANTENNA DEVICE, ELECTRONIC APPARATUS, AND PORTABLE TERMINAL

(71) Applicant: CASIO COMPUTER CO., LTD., Tokyo (JP)

(72) Inventors: Shigeru YAGI, Tokyo (JP); Youichi USHIGOME, Tokyo (JP)

(73) Assignee: CASIO COMPUTER CO., LTD., Tokyo (JP)

(21) Appl. No.: 15/010,699

(22) Filed: Jan. 29, 2016

(30) Foreign Application Priority Data
Mar. 20, 2015 (JP) 2015-057402

(51) Int. Cl. H01Q 1/38; H01Q 1/24; H01Q 9/04

(52) U.S. Cl. CPC H01Q 1/38; H01Q 9/0485; H01Q 1/243

(57) ABSTRACT

An antenna device includes an antenna element including a conductor; and a dielectric component. The antenna element includes a conductor. The dielectric component has a dielectric loss of 0.002 or greater. The dielectric component is attached to the antenna element.

### CROSS-REFERENCE TO RELATED APPLICATIONS

This application is based upon and claims the benefit of priority from the prior Japanese Patent Application No. 2015-057402, filed Mar. 20, 2015, the entire contents of which are incorporated herein by reference.

### BACKGROUND OF THE INVENTION

1. Field of the Invention

The present invention relates to an antenna device, an electronic apparatus, and a portable terminal.

2. Background Art

A typical antenna for a portable phone is a double resonance antenna covering two bands, i.e., the 800-900 MHz band and the 1.9-2.2 GHz band in Japan used by a Wideband Code Division Multiple Access (W-CDMA) (Registered Trademark) scheme, and the 800-900 MHz band and the 1.8-2.1 GHz band overseas used by a Global System for Mobilecommunications (GSM) (Registered Trademark).

GSM 1800, GSM 1900, and W-CDMA Band 1 continuously use the frequencies in the 1800-2100 MHz band. A band element has been required which has a wide bandwidth to continuously cover a wide band from 1800 to 2100 MHz. In such a circumstance, an antenna having a wide bandwidth has been required.

An antenna including a thick element that defines several current routes to provide an increased bandwidth is known (refer to Japanese Patent Application Laid-Open Application No. 2007-27906).

At antenna including a first antenna element having a length corresponding to a resonant frequency and a second antenna element having a length slightly shorter than the first element is known. These antenna elements define several current routes to provide an increased bandwidth (refer to Japanese Patent Application Laid-Open Application No. 2007-43594).

Another typical antenna includes an inverted F-shaped element that defines several current routes to provide an increased bandwidth. Still another typical antenna includes an element having such a shape that electrostatic capacitance components are generated at the end of the element to provide an increased bandwidth.

Unfortunately, these typical antennas that require element structures to increase the bandwidth thereof may have large dimensions. In addition, the intricate structures of the typical antennas require complicated matching processes. This may lead to poor production reliability (variation in product quality).

### SUMMARY OF THE INVENTION

An object of the present invention is to provide a compact device having an increased resonance bandwidth and exhibiting highly stable antenna characteristics.

According to one aspect of the present invention, there is provided an antenna device including:

an antenna element including a conductor; and

a dielectric component having a dielectric loss of 0.002 or greater, the dielectric component being attached to the antenna element.

According to another aspect of the present invention, there is provided an electronic apparatus including:

a housing;

a wireless communication unit; and

an antenna device in connection with the wireless communication unit, the wireless communication unit and the antenna device being accommodated in the housing, wherein

the antenna device includes:
an antenna element including a film conductor having a first antenna portion and a second antenna portion, the first antenna portion having a length corresponding to a first frequency, the second antenna portion having a length corresponding to a second frequency different from the first frequency, the first antenna portion and the second antenna portion being bent so as to conform to the shape of the housing of the electronic apparatus;
a conductive film ground to be grounded; and
a dielectric component having a dielectric loss of 0.002 or greater, the dielectric component being attached to at least one of the first antenna portion and the second antenna portion.

According to another aspect of the present invention, there is provided a portable terminal including:

a portable housing to be carried by a user;

a wireless communication unit; and

an antenna device in connection with the wireless communication unit, the wireless communication unit and the antenna device being accommodated in the portable housing, wherein

the antenna device includes:
an antenna element including a film conductor having a first antenna portion and a second antenna portion, the first antenna portion having a length corresponding to a first frequency, the second antenna portion having a length corresponding to a second frequency different from the first frequency, the first antenna portion and the second antenna portion being bent so as to conform to the shape of the portable housing of the electronic apparatus;
a conductive film ground to be grounded; and
a dielectric component having a dielectric loss of 0.002 or greater, the dielectric component being attached to at least one of the first antenna portion and the second antenna portion.

The present invention can provide a compact antenna device having an increased resonance bandwidth and exhibiting highly stable antenna characteristics.

### BRIEF DESCRIPTION OF THE DRAWINGS

The present invention is fully understood from the detailed description given hereafter and the accompanying drawings, which are given by way of illustration only and thus are not intended to limit the present invention, wherein:

FIG. 1 is an external view of an electronic apparatus according to an embodiment of the present invention;

FIG. 2 is a block diagram of the functional configuration of the electronic apparatus;

FIG. 3A is a plan view of an antenna device;

FIG. 3B is a cross-sectional view of the antenna device;

FIG. 4 is a circuit diagram of the configuration of a matching circuit;

FIG. 5 illustrates an equivalent basic structure of the device;

FIG. 6 illustrates the attachment of the antenna device to an upper casing;

FIG. 7 is a perspective view of the antenna device to which a dielectric component is to be attached;

FIG. 8 is a curve of the voltage standing wave ratio (VSWR) versus the frequency of an antenna device to which no dielectric component is attached; and

FIG. 9 is a curve of the VSWR versus the frequency of the antenna device to which the dielectric component is attached.

### DETAILED DESCRIPTION OF THE PREFERRED EMBODIMENT

Embodiments of the present invention will now be described in detail with reference to the attached drawings. It should be noted that the present invention may have any configuration other than those illustrated in the attached drawings.

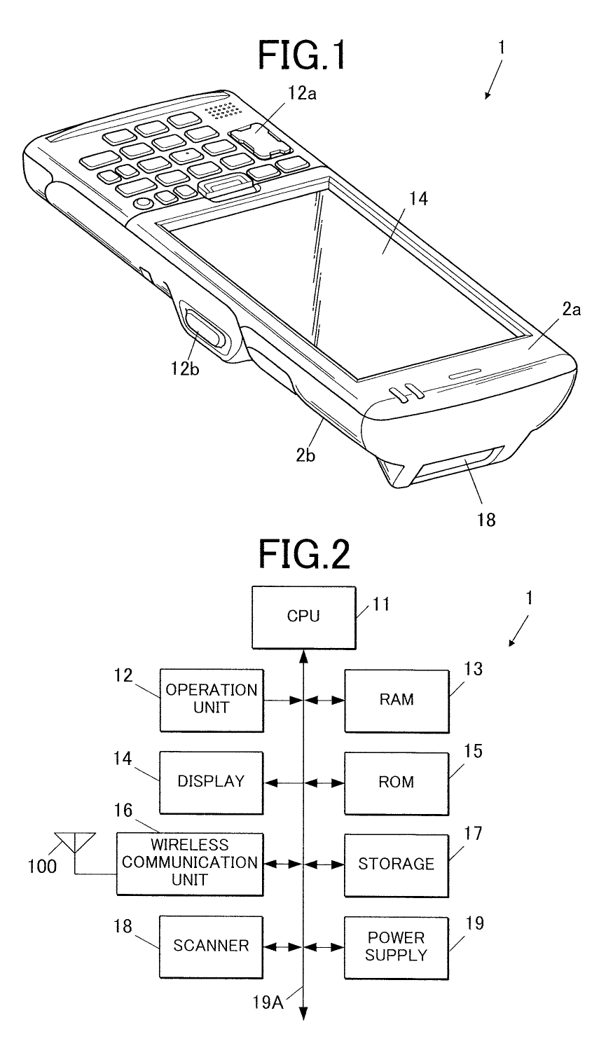

With reference to FIGS. 1 to 3, the configuration of an electronic apparatus according to an embodiment will now be described. FIG. 1 is an external view of an electronic apparatus 1 according to the embodiment of the present invention. FIG. 2 is a block diagram of the functional configuration of the electronic apparatus 1.

The electronic apparatus 1 according to the embodiment has a function of portable telephone communication (mobile communication) and serves as a handy terminal to manage commodities in a store or warehouse, for example. Instead of a handy terminal, the electronic apparatus 1 may be any wireless communication electronic apparatus, such as a smartphone, a tablet personal computer (PC), a laptop PC, a personal digital assistant (PDA), and a cellular phone.

The electronic apparatus 1 can communicate with a device, such as a server, in a communication network via a base station for portable telephone communication located around the store or warehouse, for example.

With reference to FIG. 1, the electronic apparatus 1 includes an upper casing 2a and a lower casing 2b that are composed of resin, for example. A power supply 19, a board, and other components (that are described below) are disposed between the upper casing 2a and the lower casing 2b and in the interior of the electronic apparatus 1.

The board is a printed circuit board (PCB) on which various circuit components are mounted.

The electronic apparatus 1 includes a display 14 and a key group 12a on a flat (upper) surface of the upper casing 2a. The display 14 is a liquid crystal display (LCD) or an electro-luminescent (EL) display, for example, and displays various information items. The key group 12a consists of multiple keys to receive keystroke input by a user. The key group 12a includes a menu key, character (numeric) keys, a cursor key, and a triggering key for RFID reading/writing, for example.

The electronic apparatus 1 includes a scanner 18 disposed at the end of the lower casing 2b. The scanner 18 emits a laser light beam toward a bar-code symbol, for example, and then receives the reflected light beam to read the information on the symbol.

The electronic apparatus 1 also includes side keys 12b on the opposite sides of the lower casing 2b. The side keys 12b trigger scanning by the scanner 18.

With reference to FIG. 2, the internal functional configuration of the electronic apparatus 1 will now be described.

As illustrated in FIG. 2, the electronic apparatus 1 includes a central processing unit (CPU) 11, an operation unit 12, a random access memory (RAM) 13, a display 14, a read only memory (ROM) 15, a wireless communication unit 16, an antenna device 100, a storage 17, a scanner 18, and a power supply 19.

These components of the electronic apparatus 1 are in connection with one another via a bus 19A.

The CPU 11 controls the components of the electronic apparatus 1. The CPU 11 reads a designated program from various programs in the ROM 15, deploys the program in the RAM 13, and then executes various processes in cooperation with the deployed program. In particular, the CPU 11 causes the wireless communication unit 16 to establish wireless communication with the base station through a mobile communication scheme, so that the wireless communication unit 16 communicates with an external device in a communication network in connection with the base station.

The operation unit 12 includes the key group 12a and the side keys 12b. The operation unit 12 receives keystroke inputs by the user through the key group 12a and the side keys 12b, and then sends operational information to the CPU 11 in response to the inputs by the user. Alternatively, the operation unit 12 may include a touch panel which is disposed on the screen of the display 14 and receives touch inputs by the user.

The RAM 13 is a volatile semiconductor memory that has a work area storing various data items and various programs.

The display 14 displays various information items on the display panel in response to the designations of display information from the CPU 11.

The ROM 15 is a read-only semiconductor memory storing various data items and various programs.

The wireless communication unit 16 establishes wireless communication through mobile communication schemes, i.e., GSM and W-CDMA.

In specific, the wireless communication unit 16 establishes wireless communication in two bands, i.e., the 800-900 MHz band (hereinafter referred to as “800 MHz band”) for GSM and W-CDMA and the 1.8 to 2.2 GHz band (hereinafter referred to as “2 GHz band”) for GSM and W-CDMA.

The 2 GHz band includes the bands of GSM 1800, GSM 1900, and W-CDMA Band 1.

The wireless communication unit 16 is in connection with the antenna device 100. The wireless communication unit 16 includes a wireless communication module which is composed of a modulation/demodulation circuit and a signal processing circuit, for example. Such a wireless communication unit 16 establishes wireless communication with the base station in response to the transmission and reception of radio waves and the processing on the transmitted and received signals at the antenna device 100.

Instead of the wireless communication schemes described above, the antenna device 100 and the wireless communication unit 16 may establish wireless communication through another wireless communication scheme using a different frequency (frequency band).

The storage 17 is a nonvolatile memory, for example, a readable and writable flash memory, an electrically erasable programmable ROM (EEPROM), or a battery backup RAM.

The scanner 18 is a laser scanner for reading bar-code symbols. The scanner 18 sends the scanned data to the CPU 11. The scanner 18 may be an imager of an imaging unit that reads a symbol in the form of a bar code or a two-dimensional code.

The power supply 19 is, for example, a secondary battery or a primary battery that supplies electric power to the components in the electronic apparatus 1.

The electronic apparatus 1 may include wireless communication units establishing electromagnetic field communications, such as near field communication (NFC), and radio wave wireless communication other than portable telephone communication, such as a global positioning system (GPS), wireless local area network (LAN) communication, and Bluetooth (Registered Trademark) communication; an imager; and a printer.

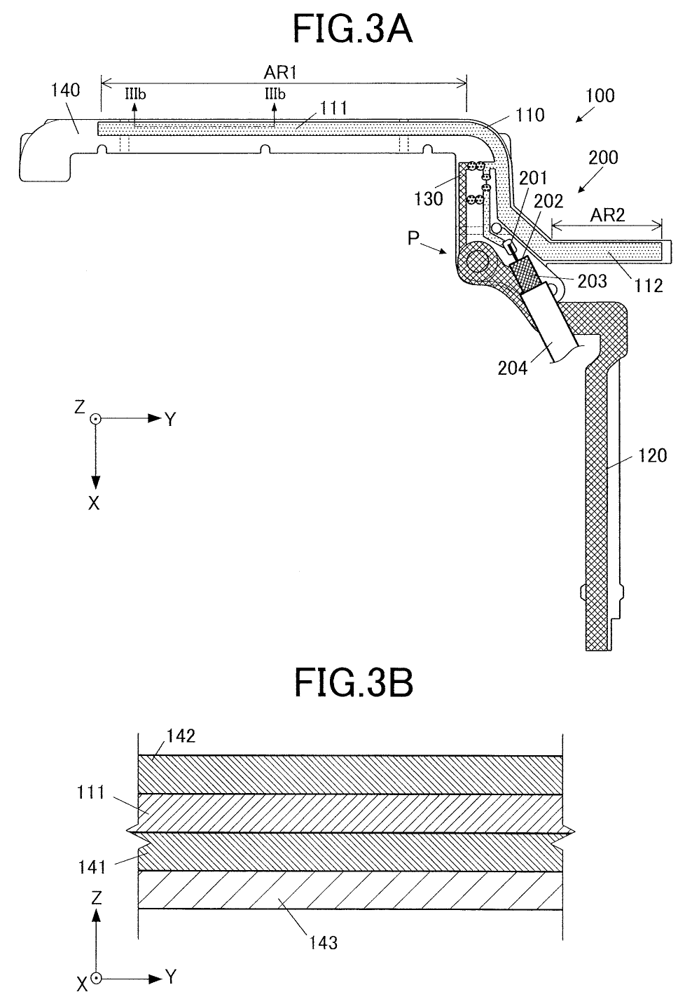

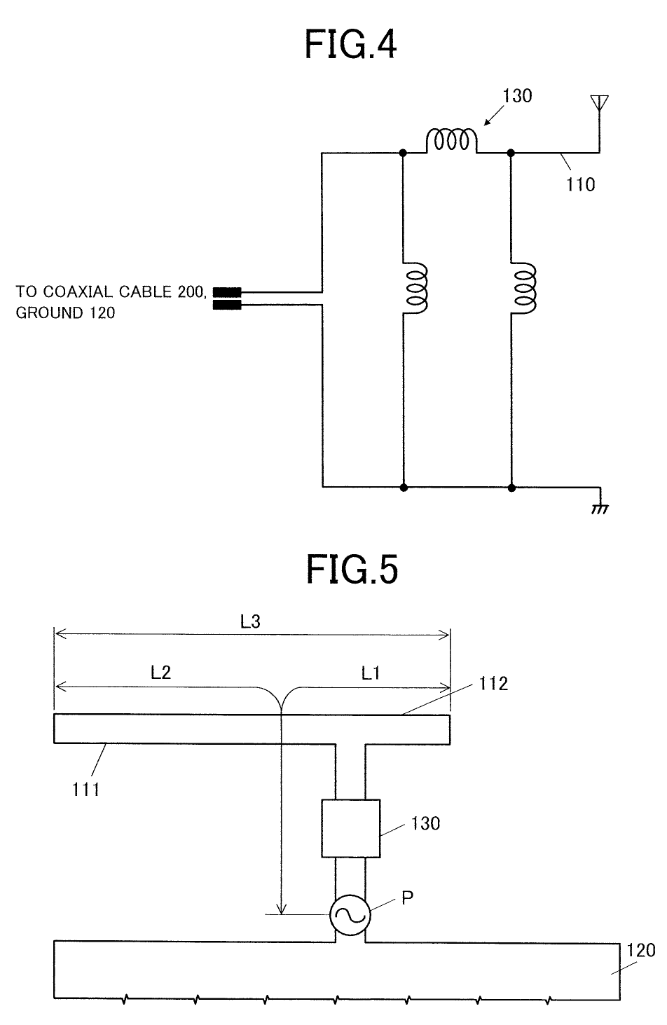

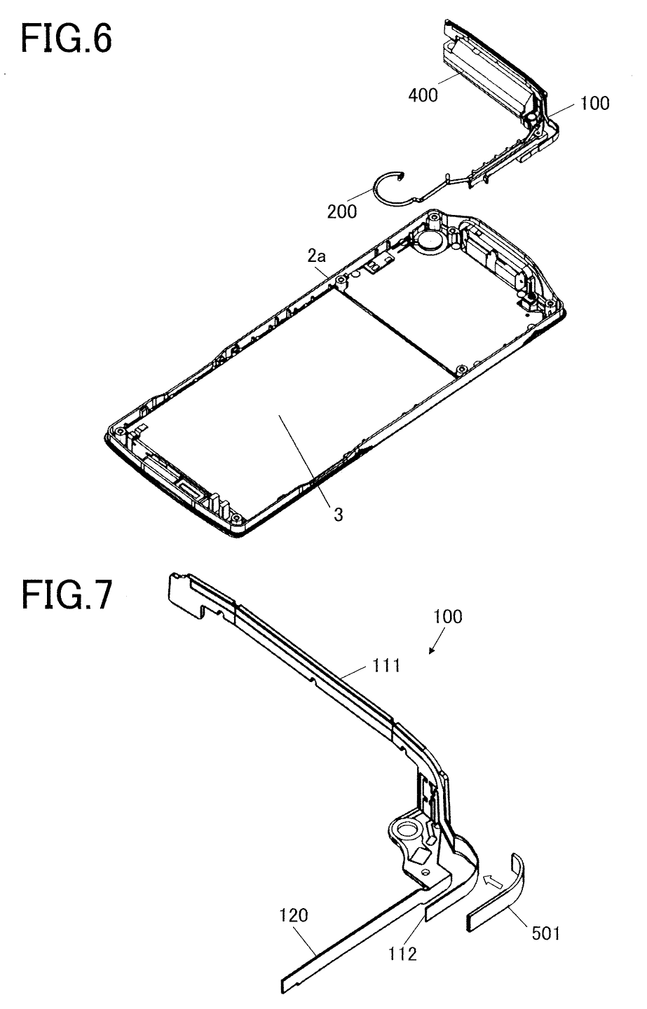

With reference to FIGS. 3 to 6, the configuration of the antenna device 100 will now be described. FIG. 3A is a plan view of the antenna device 100. FIG. 3B is a cross-sectional view of the antenna device 100. FIG. 4 is a circuit diagram of the configuration of a matching circuit 130. FIG. 5 illustrates an equivalent basic structure of the antenna device 100. FIG. 6 illustrates the attachment of the antenna device 100 to the upper casing 2a.

As illustrated in FIG. 3A, the antenna device 100 includes an antenna element 110, a ground 120, a matching circuit 130 as a matching section, and a film section 140.

The antenna element 110 is composed of, for example, a conductor pattern of rolled copper foil disposed on the film section 140. Antenna currents are transmitted through the antenna element 110. The antenna element 110 includes a first antenna portion 111 and a second antenna portion 112. The first antenna portion 111 is shaped in a strip having a linear region AR1. The second antenna portion 112 is shaped in a strip having a linear region AR2. The end of the first antenna portion 111 is directed opposite to the end of the second antenna portion 112 along the Y-axis in FIG. 3A.

The ground 120 is composed of, for example, a conductor pattern of rolled copper foil disposed on the film section 140. The ground 120 is an element to be grounded. The ground 120 is shaped in a strip, but may have any other shape.

The matching circuit 130 includes the circuit components in connection with the conductor pattern of the rolled copper foil on the film section 140, for example. The matching circuit 130 matches the impedance at the antenna element 110 with the impedance at the wireless communication module of the wireless communication unit 16 (at 50 [Ω] in general).

With reference to FIG. 4, the matching circuit 130 is a n-shaped matching circuit including three inductors connected to define a π shape and disposed in the middle of the antenna element 110. Instead of the π-shaped matching circuit including the inductors, the matching circuit 130 may be of any type, for example, a shaped matching circuit including other circuit elements or an L-shaped matching circuit.

With reference to FIG. 3A, a first end of a coaxial cable 200 is in connection with the ground 120 and the matching circuit 130. A second end of the coaxial cable 200 is in connection with the wireless communication module of the wireless communication unit 16. The coaxial cable 200 consists of an internal conductor 201 that is a single copper wire, for example, an insulator 202 that covers the internal conductor 201, an external conductor 203 that is, for example, a mesh copper wire covering the insulator 202, and an insulating protector 204 that covers the external conductor 203.

The internal conductor 201 at the first end of the coaxial cable 200 is soldered with a first end of the matching circuit 130. The external conductor 203 is soldered with a first end of the ground 120. The coaxial cable 200 is in connection with the antenna device 100 at the feeding point P.

With reference to FIG. 3B, the film section 140 consists of films 141 and 142 and a reinforcing member 143. The antenna element 110, the ground 120, and the matching circuit 130 are supported between the films 141 and 142. The films 141 and 142 are thin and flexible base films composed of insulating materials, such as polyimide. The reinforcing member 143 is composed of an insulating material, such as epoxy impregnated glass. The reinforcing member 143 reinforces the film section 140.

As illustrated in FIG. 3B which is a cross-sectional view of the linear region AR1 of the antenna device 100, the reinforcing member 143, the film 141, the first antenna portion 111, and the film 142 are stacked in this sequence from the −Z direction to the +Z direction in FIG. 3B. For example, the reinforcing member 143 has a thickness of 200 to 450 μm, the film 141 (and the film 142) has a thickness of 12.5 μm, and the first antenna portion 111 (and the second antenna portion 112 and the ground 120) has a thickness of 18 μm.

The dielectric component 501 (not shown in FIGS. 3A and 33) is attached to at least one of the linear region AR1 of the first antenna portion 111 and the linear region AR2 of the second antenna portion 112 with a double-sided adhesive tape, for example.

The dielectric component 501 has a tan δ value (dielectric loss, dielectric tangent) of 0.002 or greater. The dielectric component 501 is composed of an appropriate material having a tan δ value satisfying requirements on, for example, communication.

A tan δ value of 0.002 is determined through an experiment demonstrating that the use of a dielectric component composed of a material having a tan δ value of 0.002 or more can generally establish preferred communication. Although the dielectric component according to the embodiment is composed of a carbon-based rubber sheet, the dielectric component may be composed of any other dielectric material, such as rubber and resin.

The dielectric component has a dielectric constant (relative permittivity) of about 3 to 4, in specific, 3.5, for example.

Tan δ indicates the amount of an electric energy loss in a capacitor. The antenna element 110 to which the dielectric component 501 is attached can provide a wavelength shortening effect corresponding to the dielectric constant of the dielectric component 501.

The antenna element 110 provided with the dielectric component 501 having a tan δ value of 0.002 or greater provides an increased resonance bandwidth, whereas it provides an increased resonant voltage standing wave ratio (VSWR) and a decreased radiant efficiency (lower Q factor) at the best resonance point.

The dielectric component 501 attached to at least one of the linear regions AR1 and AR2 can be shaped in a strip. In this case, the dielectric component 501 can be cut into a desired length at its end. In other words, the length of the dielectric component 501 can be adjusted by a simple process. Instead of the linear regions AR1 and AR2, the dielectric component 501 may be attached to any other part of the first antenna portion 111 and the second antenna portion 112.

The dielectric component 501 is preferably attached to the surface of the film 142 remote from the reinforcing member 143. Alternatively, the antenna device 100 may include no reinforcing member 143. In another embodiment, the dielectric component 501 may be attached to the film 141 (the reinforcing member 143).

The principle of the operation of the antenna device 100 will now be described with reference to FIG. 5.

With reference to FIG. 5, which illustrates an equivalent basic structure of the antenna device 100, the length L1 is defined between the feeding point P and the end of the second antenna portion 112, and the length L2 is defined between the feeding point P and the end of the first antenna portion 111.

The length L1 has a ¼ wavelength of 2 GHz band to cause resonance in the 2 GHz band.

The length L2 has a ¼ wavelength of 800 MHz band to cause resonance in the 800 MHz band.

The antenna characteristics of the first antenna portion 111 and the second antenna portion 112 can be separately controlled by attaching the dielectric component 501 to the first antenna portion 111 and/or the second antenna portion 112.

The matching circuit 130 is disposed at a common portion between the first antenna portion 111 and the second antenna portion 112, that the matching by the matching circuit 130 cause effects on the 800 MHz band and the 2 GHz band.

The total length L3 of the first antenna portion 111 and the second antenna portion 112 is longer than the lengths L1 and L2. The length L3 causes resonance in a frequency band lower than the 2 GHz band and the 800 MHz band. Since the lengths L1 and L2 are separately variable, the resonance corresponding to the length L3 is not used for the wireless communication.

FIG. 3A is an illustrated parts breakdown of the antenna device 100. With reference to FIG. 6, the antenna device 100 is appropriately bent into a three-dimensional shape and is attached to an antenna unit 400 in actual use. The antenna unit 400 is a support composed of resin, for example.

The antenna device 100 attached to the antenna unit 400 is to be attached to an upper casing 2a on which a body unit 3 is mounted. The body unit 3 is a circuit board on which various circuit components including a wireless communication module of the wireless communication unit 16 are mounted. The detailed illustration of the body unit 3 is omitted in FIG. 6.

The antenna characteristics of the antenna device 100 will now be described with reference to FIGS. 7 to 9.

FIG. 7 is a perspective view of the antenna device 100 to which a dielectric component 501 is attached.

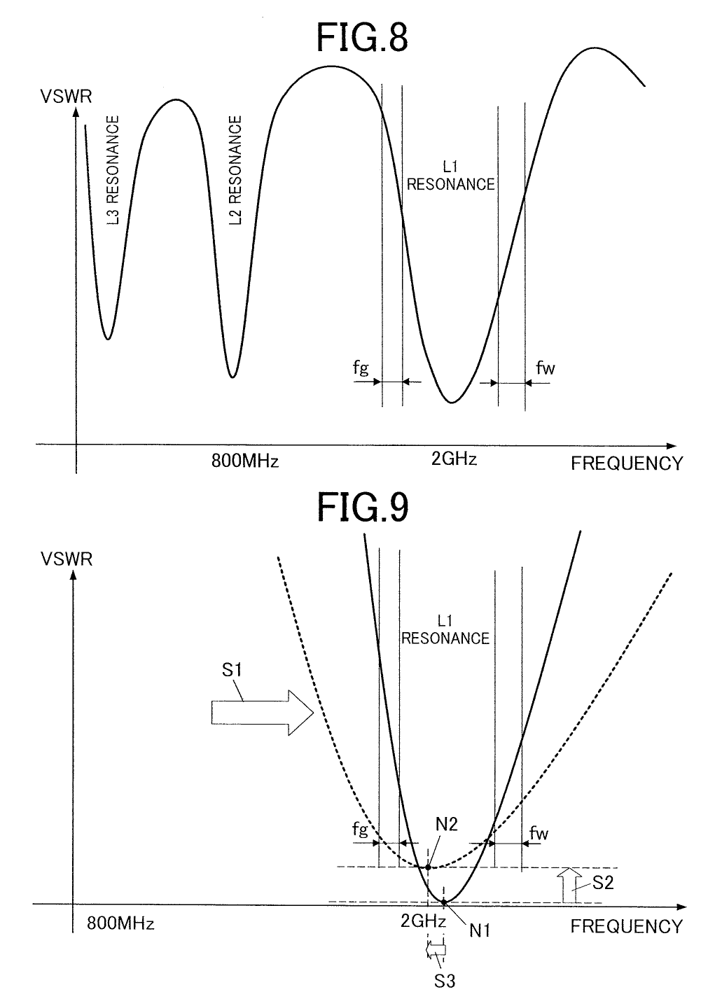

FIG. 8 is a curve of the voltage standing wave ratio (VSWR) versus the frequency of an antenna device 100 to which no dielectric component 501 is attached.

FIG. 9 is a curve of the VSWR versus the frequency of the antenna device 100 to which the dielectric component 501 is attached.

FIG. 7 illustrates the attachment of a dielectric component 501 to the linear region AR2 of the antenna device 100. In this case, the wireless communication unit 16 establishes wireless communication of GSM 1800 and W-CDMA and 1 in the 2 GHz band.

As illustrated in FIG. 7, the antenna device 100 is appropriately bent into a three-dimensional shape conforming to the shape of an available space defined by the shape of the housing (the shape of the component in the housing, for example) in the electronic apparatus 1. The dielectric component 501 is attached to the antenna device 100, and the antenna device 100 provided with the dielectric component 501 is attached to the antenna unit 400.

The second antenna portion 112 to which the dielectric component 501 is attached is appropriately bent into a curved shape conforming to the housing of the antenna device 100. The dielectric component 501 attached to the curved region AR2 of the second antenna portion 112 has a curved shape conforming to the curved region AR2 of the second antenna portion 112.

FIG. 8 is a curve of the VSWR versus the frequency of the antenna device 100 before the attachment of the dielectric component 501 (to which no dielectric component 501 is attached).

In FIG. 8, the frequency band fg is a frequency band for GSM 1800, and the frequency band fw is a frequency band for W-CDMA Band 1. The curve of the VSWR versus the frequency of the antenna device 100 to which no dielectric component 501 is attached is indicated by a solid line. The antenna device 100 to which no dielectric component 501 is attached is resonated at the resonant frequencies corresponding to the lengths L1, L2, and L3, respectively.

The resonant frequency band corresponding to the length L1 includes the frequency bands fg and fw. The best resonance point (minimum resonance point) (the smallest VSWR in this frequency band) corresponding to the length L1 is located between the frequency bands fg and fw. The band between the frequency bands fg and fw which provides a small VSWR is not used for wireless communication. The frequency bands fg and fw cannot provide relatively small and appropriate VSWRs.

FIG. 9 illustrates the VSWR versus the frequencies of the antenna device 100 to which the dielectric component 501 is attached. In FIG. 9, the VSWR curve of the antenna device 100 to which the dielectric component 501 is attached is indicated by the dot-line, while the VSWR curve of the antenna device 100 to which no dielectric component 501 is attached is indicated by the solid line, for comparison.

As indicated by the arrow S1, the VSWR curve of the resonance corresponding to the length L1 of the antenna device 100 to which the dielectric component 501 having a tan δ value (dielectric loss, dielectric tangent) is attached has a larger bandwidth than that of the antenna device 100 to which no dielectric component 501 is attached.

As indicated by the arrow S2, the VSWR at the best resonance point N2 corresponding to the length L1 of the antenna device 100 to which the dielectric component 501 is attached is greater than the VSWR at the best resonance point N1 of the antenna device 100 to which no dielectric component 501 is attached. The Q factor at the best resonance point N2 is smaller than the Q factor at the best resonance point N1.

The best resonance point N2 corresponding to the length L1 of the antenna device 100 to which the dielectric component 501 is attached, however, is shifted to a frequency lower than the best resonance point N1 by the wavelength shortening effect of the dielectric component 501, as indicated by the arrow S3. The frequency at the best resonance point N2 corresponding to the length L1 of the antenna device 100 to which the dielectric component 501 is attached is preferably outside of the frequency bands fg and fw that are used for the wireless communication.

The VSWRs in the frequency bands fg and fw of the antenna device 100 to which the dielectric component 501 is attached are advantageously smaller than the VSWRs in the frequency band fg and fw of the antenna device 100 to which no dielectric component 501 is attached.

The bandwidth indicated by the arrow S1 and the VSWR at the best resonance point N2 indicated by the arrow S2 can be controlled by changing the tan δ value of the dielectric component 501 through use of any other material for the dielectric component 501, changing the dimensions of the dielectric component 501, or changing the site to which the dielectric component 501 is attached.

For example, as the tan δ value of the dielectric component 501 increases, the bandwidth indicated by the arrow S1 increases and the VSWR indicated by the arrow S2 increases (the Q factor decreases). In addition, the frequency at the best resonance point N2 indicated by the arrow S3 can be controlled by changing the dielectric constant of the dielectric component 501 through use of any other material for the dielectric component 501, for example.

The antenna device 100 according to the embodiment of the present invention includes the antenna element 110 and the dielectric component 501 having a dielectric loss of 0.002 or greater and attached to the antenna element 110.

The antenna device 100 including a dielectric component 501 can provide an increased resonance bandwidth due to the dielectric loss thereof. In addition, the antenna device 100 eliminates the need for an additional antenna structure in the antenna element 110 to increase the bandwidth and thus can have a simple structure and can be compact.

In such an antenna device 100, the structure to determine the bandwidth and the Q factor is independent of the structure of the antenna element. The antenna device 100 thus can have a simple structure, which facilitates the control of the matching and the antenna characteristics. This can reduce the variation in product quality and enhance the stability of the antenna characteristics.

In addition, the resonance bandwidth can be readily increased by adjusting any parameter of the dielectric component 501, even after the actual mounting of the antenna device 100 on the housing.

The antenna element 110 consists of the first antenna portion 111 and the second antenna portion 112, and the dielectric component 501 is attached to at least one of the first antenna portion 111 and the second antenna portion 112. The resonance bandwidths of the first antenna portion 111 and the second antenna portion 112 therefore can be separately increased by the attachment of the dielectric component 501 at a selected antenna portion.

The resonance frequencies of the first antenna portion 111 and the second antenna portion 112 are different from each other (800 MHz band and 2 GHz band). The resonance bandwidths of the first antenna portion 111 and the second antenna portion 112 can be separately increased by the attachment of the dielectric component 501 at a selected antenna portion.

The antenna device 100 includes the matching circuit 130 for impedance matching disposed on the antenna element 110. This eliminates the need for an additional matching circuit in the wireless communication unit 16, and thus can simplify the structure of the antenna device 100 and facilitate the impedance matching of the first antenna portion 111 and the second antenna portion 112.

Furthermore, the bandwidth can be increased by the use of the dielectric component 501, without the adjustment of the Q factor by the matching circuit 130. This can simplify the structure of the matching circuit 130, and allow the antenna device 100 to be flexibly mounted to the housing without modification in the matching circuit 130. Such an antenna device 100 can also be mounted on another electronic apparatus including a different housing, which leads to expanded versatility of the antenna device 100.

The antenna device 100 includes the conductive ground 120 to be grounded and the insulating films 141 and 142. The antenna element 110 and the ground 120 are disposed on the film 141 (between the films 141 and 142). The antenna device 100 thus can be a film antenna device.

The dielectric component 501 is attached to at least one of the linear region AR1 and AR2 of the antenna element 110. The dielectric component 501 can be readily processed by cutting a longitudinal end thereof to increase the bandwidth.

The electronic apparatus 1 includes the antenna device 100 and the wireless communication unit 16 establishing wireless communication through the antenna device 100. Such an electronic apparatus 1 can establish wireless communication over an increased resonance bandwidth provided by the antenna device 100.

The embodiment of the present invention describes an exemplary antenna device, an exemplary electronic apparatus, and an exemplary portable terminal. The embodiment of the present invention also can be applied to any other device.

For example, the antenna device 100 may have any structure other than a double resonance structure including the first antenna portion 111 and the second antenna portion 112 having different resonance frequencies from each other.

The antenna device 100 may have a single resonance structure including a single antenna portion or a multiple resonance structure including three or more antenna portions. For example, the antenna device 100 may be a diversity antenna, which includes several antenna portions having the same resonance frequency.

Although the antenna device 100 is a film antenna device in the above embodiment, the antenna device 100 may be of any type. For example, the antenna device 100 may include a rod antenna element and a dielectric component having a dielectric loss of 0.002 or greater may be attached to the antenna element.

It should be understood that the detailed configuration and the detailed operation of the components of the electronic apparatus 1 according to the embodiment described above can be appropriately modified without departing from the scope of the present invention.

1. An antenna device comprising:
an antenna element including a conductor; and
a dielectric component having a dielectric loss of 0.002 or greater, the dielectric component being attached to the antenna element.

2. The antenna device according to claim 1, wherein
the antenna element comprises a plurality of antenna portions, and
the dielectric component is attached to at least one of the antenna portions.

3. The antenna device according to claim 2, wherein the antenna portions have resonance frequencies different from each other.

4. The antenna device according to claim 1, further comprising a matching section which is disposed on the antenna element and carries out impedance matching.

5. The antenna device according to claim 1, further comprising:
a conductive ground to be grounded; and
an insulating film, wherein
the antenna element and the conductive ground are disposed on the insulating film.

6. The antenna device according to claim 1, wherein the antenna element has a linear region, the dielectric component being attached to the linear region.

7. An electronic apparatus comprising:
the antenna device according to claim 1; and
a wireless communication unit establishing wireless communication through the antenna device.

8. An electronic apparatus comprising:
a housing;
a wireless communication unit; and
an antenna device in connection with the wireless communication unit, the wireless communication unit and the antenna device being accommodated in the housing, wherein
the antenna device includes:
an antenna element including a film conductor having a first antenna portion and a second antenna portion, the first antenna portion having a length corresponding to a first frequency, the second antenna portion having a length corresponding to a second frequency different from the first frequency, the first antenna portion and the second antenna portion being bent so as to conform to the shape of the housing of the electronic apparatus;
a conductive film ground to be grounded; and
a dielectric component having a dielectric loss of 0.002 or greater, the dielectric component being attached to at least one of the first antenna portion and the second antenna portion.

9. The electronic apparatus according to claim 8, further comprising a matching section which is disposed on the antenna element and carries out impedance matching.

10. The electronic apparatus according to claim 8, wherein the antenna element has a linear region, the dielectric component being attached to the linear region.

11. A portable terminal comprising:
a portable housing to be carried by a user;
a wireless communication unit; and
an antenna device in connection with the wireless communication unit, the wireless communication unit and the antenna device being accommodated in the portable housing, wherein
the antenna device includes:
an antenna element including a film conductor having a first antenna portion and a second antenna portion, the first antenna portion having a length corresponding to a first frequency, the second antenna portion having a length corresponding to a second frequency different from the first frequency, the first antenna portion and the second antenna portion being bent so as to conform to the shape of the portable housing of the electronic apparatus;
a conductive film ground to be grounded; and
a dielectric component having a dielectric loss of 0.002 or greater, the dielectric component being attached to at least one of the first antenna portion and the second antenna portion.

12. The portable terminal according to claim 11, further comprising a matching section which is disposed on the antenna element and carries out impedance matching.

13. The portable terminal according to claim 11, wherein the antenna element has a linear region, the dielectric component being attached to the linear region.
